(19) United States
(12) Patent Application Publication
(10) Pub. No.: US 2024/0429711 A1
(43) Pub. Date: Dec. 26, 2024

(54) MAGNETIC BIAS ACTIVE SUPPRESSION METHOD AND SYSTEM OF HYBRID DISTRIBUTION TRANSFORMER

(71) Applicant: XI'AN JIAOTONG UNIVERSITY, Xi'an (CN)

(72) Inventors: Yibin LIU, Xi'an (CN); Deliang LIANG, Xi'an (CN); Shichao LI, Xi'an (CN); Zihan KONG, Xi'an (CN); Jia LI, Xi'an (CN); Hao JIN, Xi'an (CN); Lishi ZHANG, Xi'an (CN)

(73) Assignee: XI'AN JIAOTONG UNIVERSITY, Xi'an (CN)

(21) Appl. No.: 18/763,429

(22) Filed: Jul. 3, 2024

Related U.S. Application Data
(63) Continuation of application No. PCT/CN2024/085890, filed on Apr. 3, 2024.

(30) Foreign Application Priority Data
Jun. 20, 2023 (CN) 2023101421100

(51) Int. Cl. H02J 3/24; H02J 13/00

(52) U.S. Cl. CPC H02J 3/24; H02J 13/00002

(57) ABSTRACT

The disclosure discloses a magnetic bias active suppression method and system of a hybrid distribution transformer, whether the HDT is closed or not is judged based on the grid-side current, and accordingly smooth switching of the two sets of control strategies is achieved; excitation currents of an HDT main transformer and an isolation transformer are calculated based on a magnetic potential balance principle, and nonlinear feedback is performed, and the excitation currents are superposed after an original control instruction of an HDT converter, so that magnetic bias suppression is realized on the basis of ensuring an HDT grid-side current and load voltage control function. According to the system, a complex and expensive iron core magnetic flux sensor does not need to be additionally arranged, and the DC magnetic bias of the HDT under any working condition can be eliminated while the basic control function of the HDT is not affected.

### CROSS-REFERENCE TO RELATED APPLICATIONS

The application claims priority to Chinese patent application No. 2023101421100, filed on Feb. 20, 2023, the entire contents of which are incorporated herein by reference.

### TECHNICAL FIELD

The present disclosure pertains to the field of transformer technology, and more particularly to a magnetic bias active suppression method and system of a hybrid distribution transformer.

### BACKGROUND

A hybrid distribution transformer (HDT) is a new type of distribution transformer that has the basic feature of integrating a conventional power frequency transformer with a back-to-back voltage source type converter. In many configurations, a converter high-low crossover HDT constructed with an isolation transformer and a three-winding main transformer has significant advantages. In particular, in this HDT solution, the transformer ratio selection range is large, the circuit parameter selection range is wide, and the device selection is flexible and convenient. However, in actual operation, DC bias is inevitable in the iron cores of the two transformers of such HDTs. When the bias is severe, it often leads to magnetic saturation. Once the iron core is saturated, the excitation inductance will decrease sharply, causing a large excitation inrush current, which will further lead to the inability of the HDT to operate normally.

Due to the significant dispersion in the closing time of traditional mechanical circuit breakers, the residual magnetism in the iron core is difficult to accurately measure. Therefore, it is not possible to perform no-load closing at the theoretically desired optimal moment, resulting in the inevitability of magnetic bias in the HDT main transformer and the inability to eliminate the excitation inrush current. Although relay protection devices in the distribution network can withstand a certain range of excitation inrush current without causing protection malfunctions, the excitation inrush current contains a large amount of harmonics and DC components. Given the large number of distribution transformers and the high overall closing frequency, the pollution caused to the entire distribution network system cannot be underestimated.

For the isolation transformer of the HDT, its terminal voltage is the compensation voltage. The polarity and amplitude of this compensation voltage will change with the fluctuation of the grid voltage, making it easier for the iron core of the isolation transformer to experience DC bias, which in turn leads to excitation inrush current. If no measures are taken, the only option is to increase the iron core cross-section of the isolation transformer as much as possible to withstand DC bias, but this will inevitably waste a large amount of copper and iron materials.

Regarding the above issues, existing HDT control strategies rarely address them, making the magnetic saturation problem caused by DC bias a bottleneck that hinders the normal operation of HDT in the grid. In HDT, the two transformers are connected to their respective converters in a back-to-back manner. One of the converters is called the current compensation converter, which is connected to the control winding of the main transformer. Its main purpose is to eliminate the harm caused to the distribution network by harmful currents such as harmonics, reactive power, and asymmetry in the load current. The other converter is called the voltage compensation converter, which is connected to the isolation transformer through the valve-side winding. Its main purpose is to eliminate the adverse effects of voltage fluctuations and asymmetry in the distribution network on the power supply to the load.

In fact, the control functions of the two converters in HDT are far more than just the aforementioned voltage and current regulation. With the addition of new control strategies, it is expected that the magnetic flux of the iron cores of the two transformers can be further regulated. Existing research has proposed a magnetic bias suppression strategy based on flux linkage tracking, but flux linkage tracking requires feedback of the iron core flux linkage, and the DC component of the flux linkage cannot be accurately and quickly obtained through observation methods such as terminal voltage integration. Although magnetic flux sensors can be installed in each iron core leg to obtain the iron core flux linkage, the magnetic flux sensors are expensive and extremely difficult to install in transformer iron cores. In addition, the new magnetic flux sensors require corresponding A/D conditioning circuits and control circuit acquisition interfaces. Therefore, adding magnetic flux measurement feedback will greatly increase the manufacturing difficulty of HDT, thereby significantly reducing its cost-effectiveness.

### SUMMARY

The object of this disclosure is to overcome the shortcomings of existing technologies and provide a magnetic bias active suppression method and system of a hybrid distribution transformer, in order to address the lack of suppression measures for the magnetic bias of the main transformer in the hybrid distribution transformer (HDT) in existing technologies. The method of this disclosure can establish a steady-state magnetic flux before closing, and achieve magnetic bias suppression by superimposing nonlinear feedback of excitation current after closing, thus eliminating the need for installing flux linkage sensors. DC magnetic bias can be suppressed without affecting the original control functions of HDT, effectively overcoming the bottleneck problem of magnetic saturation in HDT.

In order to achieve the above object, the present disclosure is implemented with the following technical solutions:

A magnetic bias active suppression method of a hybrid distribution transformer, including the steps of:
step 1, judging whether the HDT is closed based on a grid-side current, and in response to determining that the HDT is not closed, executing step 2; in response to determining that the HDT is closed, executing step 3;
step 2, controlling a HDT current compensation converter by a main transformer pre-magnetizing strategy and a main transformer excitation current superposition feedback strategy, and controlling a HDT voltage compensation converter by an isolation transformer pre-magnetizing strategy and a main transformer and isolation transformer excitation current superposition feedback strategy;
stabilizing a load voltage through an output of the HDT current compensation converter, limiting a zero-sequence circulating current within a grid-side winding in a delta connection; compensating for grid-side voltage fluctuations by an output of the HDT voltage compensation converter;
step 3, controlling the HDT current compensation converter by a grid-side current control strategy and a main transformer excitation current superposition feedback strategy, and controlling the HDT voltage compensation converter by a load voltage control strategy and the main transformer and isolation transformer excitation current superposition feedback strategy; and
making the grid-side current sinusoidally symmetric by the output of the HDT current compensation converter, and stabilizing the load voltage by the output of the HDT voltage compensation converter.

Further improvements of the disclosure are:

Preferably, in step 1, the grid-side current of a main transformer is measured, and the sum of three phase absolute values of the grid-side current is obtained from the grid-side current, and when the sum is greater than a set threshold value, the HDT is in the closed state, and when the sum is less than 0, the HDT is in the open state.

Preferably, in step 2, the main transformer pre-magnetizing strategy is: inputting a d-axis load voltage, a q-axis load voltage, and a 0-axis load voltage of a secondary winding and a grid-side current 0-axis component into synchronous rotation coordinates, obtaining deviations by respectively subtracting them by respective reference signals, inputting each deviation into each axis PI controller, and taking outputs of a d-axis PI controller and a q-axis controller as d-axis and q-axis output instructions of a total controller; taking the sum of the output of a load voltage 0-axis PI controller and the output of a grid-side current 0-axis PI controller as a 0-axis output instruction.

Preferably, in step 2, the isolation transformer pre-magnetizing strategy is: obtaining a d-axis load voltage, a q-axis load voltage and a 0-axis load voltage of a grid-side winding, obtaining deviations by respectively subtracting them by respective reference signals, inputting each deviation into each axis PI controller, and inputting an output value of each axis PI controller into a HDT voltage compensator.

Preferably, in step 3, the grid-side current control strategy is: obtaining a d-axis grid-side current, a q-axis grid-side current and a 0-axis grid-side current of the main transformer, obtaining deviations by respectively subtracting them by respective reference signals, inputting each deviation into each axis PI controller, and inputting an output of each axis PI controller into a HDT current compensation converter.

Preferably, in step 3, the load voltage control strategy is: inputting a d-axis load voltage, a q-axis load voltage and a 0-axis load voltage of the secondary winding into the synchronous rotation coordinates, obtaining deviations by respectively subtracting them by respective reference signals, inputting each deviation into each axis PI controller, and inputting an output value of each axis PI controller into the HDT voltage compensator.

Preferably, in step 2 and step 3, the main transformer excitation current superposition feedback strategy is: after performing symbolic root finding for the excitation current of each phase of the main transformer, multiplying the respective root result by a feedback coefficient, and obtaining an output value of the HDT current compensation converter by subtracting each product by an original modulation signal of each phase.

Preferably, in step 2 and step 3, the main transformer and isolation transformer excitation current superposition feedback strategy is: obtaining the excitation current of each phase of the main transformer and the excitation current of each phase of the isolation transformer; multiplying the excitation current of each phase of the main transformer by a feedback coefficient Kimlt, and multiplying the excitation current of each phase of the isolation transformer by a feedback coefficient Kim2; after performing root finding for each product, obtaining a final modulation signal of each phase by superimposing the root value onto an original modulation signal of each phase; and inputting the final modulation signal into the HDT voltage compensation converter.

Preferably, in step 2, the feedback coefficient Kimlt is approximately taken as 0; in step 3, the feedback coefficient Kimlt is approximately taken as 0.

A magnetic bias active suppression system of a hybrid distribution transformer, including:
a judging module, used for judging whether the HDT is closed based on a grid-side current, and in response to determining that the HDT is not closed, executing a non-closure module; in response to determining that the HDT is closed, executing a closure module;
a non-closure module, used for controlling a HDT current compensation converter by a main transformer pre-magnetizing strategy and a main transformer excitation current superposition feedback strategy, and controlling a HDT voltage compensation converter by an isolation transformer pre-magnetizing strategy and a main transformer and isolation transformer excitation current superposition feedback strategy;
stabilizing a load voltage through an output of the HDT current compensation converter, limiting a grid-side zero-sequence current; compensating for grid-side voltage fluctuations by an output of the HDT voltage compensation converter;
a closure module, used for controlling the HDT current compensation converter by a grid-side current control strategy and a main transformer excitation current superposition feedback strategy, and controlling the HDT voltage compensation converter by a load voltage control strategy and the main transformer and isolation transformer excitation current superposition feedback strategy; and
making the grid-side current sinusoidally symmetric by the output of the HDT current compensation converter, and stabilizing the load voltage by the output of the HDT voltage compensation converter.

Compared with the prior art, the present disclosure has the following beneficial effects:

This disclosure discloses a magnetic bias active suppression method of a hybrid distribution transformer. This method studies the HDT magnetic bias suppression method based on working condition detection and excitation current feedforward on the basis of existing equipment. By detecting the currents of the primary winding, secondary winding, control winding, and valve-side winding of the HDT, the method indirectly calculates the excitation currents of the main transformer and isolation transformer of the HDT according to the magnetic potential balance principle. Aiming at the difference in the magnetic bias suppression mechanism before and after no-load closing, an HDT control strategy suitable for different working conditions is constructed, and enables smooth switching. On this basis, a proportional controller is used to perform nonlinear feedback on the excitation currents of the main transformer and isolation transformer, which are respectively superimposed on the original current and voltage compensation converter control instructions, thereby suppressing the DC magnetic bias of the HDT while achieving HDT grid current and load voltage control, and further eliminating the harm caused by magnetic saturation, inrush current, and other factors to the HDT. The purpose of actively controlling the iron core flux linkage of the HDT is to suppress magnetic saturation, therefore, it is no longer necessary to accurately track the reference signal in real-time for the iron core flux linkage. For transformers, before the iron core magnetic flux saturation, the excitation current is close to 0, and only when the iron core magnetic flux exceeds the saturation point and enters the saturation section, will the excitation current increase sharply. Therefore, the DC magnetic bias can be limited by feeding back the excitation current. Compared with the iron core magnetic flux, the excitation current of this disclosure can be approximately calculated based on the magnetic potential balance principle from the currents of various windings, and the winding currents originally need to be measured when improving the comprehensive performance of the voltage and current control system of the HDT. Therefore, excitation current feedback does not require adding new sensors and conditioning circuit investments, the realization is simple, and it is more practical.

The disclosure further discloses a magnetic bias active suppression system of a hybrid distribution transformer, two sets of HDT control strategies are designed according to a magnetic bias suppression mechanism before and after no-load closing, whether the HDT is closed or not is judged based on the grid-side current, and accordingly smooth switching of the two sets of control strategies is achieved; excitation currents of an HDT main transformer and an isolation transformer are calculated based on a magnetic potential balance principle, nonlinear feedback is performed on the excitation currents of the main transformer and the isolation transformer, and the excitation currents are superposed after an original control instruction of an HDT converter, so that magnetic bias suppression is realized on the basis of ensuring an HDT grid-side current and load voltage control function. According to the system, a complex and expensive iron core magnetic flux sensor does not need to be additionally arranged, a complex magnetic flux observation algorithm does not need to be adopted either, and the DC magnetic bias of the HDT under any working condition can be eliminated while the basic control function of the HDT is not affected.

### BRIEF DESCRIPTION OF DRAWINGS

FIG. 1 is a HDT main circuit configuration solution.

FIG. 2 is synchronization signal generation and required coordinate transformation voltages and currents.

FIG. 3 is a current compensation converter control strategy.

FIG. 4 is a HDT DC bus voltage outer loop control strategy.

FIG. 5 is a voltage compensation converter control strategy.

### DETAILED DESCRIPTION OF THE EMBODIMENTS

The disclosure is described in further detail below with reference to the accompanying drawings:

In one embodiment of the present disclosure, there is disclosed a magnetic bias active suppression method of a hybrid distribution transformer based on working condition switching and superimposition feedback of excitation current, two sets of HDT control strategies are designed according to a magnetic bias suppression mechanism before and after no-load closing, whether the HDT is closed or not is judged based on the grid-side current, and accordingly smooth switching of the two sets of control strategies is achieved; excitation currents of an HDT main transformer and an isolation transformer are calculated based on a magnetic potential balance principle, nonlinear feedback is performed on the excitation currents of the main transformer and the isolation transformer, and the excitation currents are superposed after an original control instruction of an HDT converter, so that magnetic bias suppression is realized on the basis of ensuring an HDT grid-side current and load voltage control function. Specifically, the method includes the steps of:

Step 1, whether the HDT is closed is judged based on a grid-side current.

The grid-side current of a main transformer is measured, and the sum of three phase absolute values of the grid-side current is obtained, and when the sum of the three phase absolute values of the grid-side current is greater than a set threshold value, which is a small threshold value slightly greater than 0, a grid-side circuit breaker is determined to be in the closed state, and when the sum of the three phase absolute values of the grid-side current is less than 0, the grid-side circuit breaker is in the open state.

Step 2, in response to determining that the HDT is not closed before closing. A load voltage is stabilized through the HDT current compensation converter, a zero-sequence circulating current within a grid-side winding in a delta connection is limited, and grid-side voltage fluctuations are compensated by the HDT voltage compensation converter. A current compensation converter CVp is controlled by a main transformer pre-magnetizing strategy CS2 and a main transformer excitation current superposition feedback strategy CS3; at the same time, a voltage compensation converter CVt is controlled by an isolation transformer pre-magnetizing strategy CS5 and a main transformer and isolation transformer excitation current superposition feedback strategy CS6.

Specifically, the main transformer pre-magnetizing strategy CS2 is such that, for the current compensation converter, the d/q/0-axis load voltages and the 0-axis grid-side current are fed back into synchronous rotation coordinates, based on which the output of the load voltage PI controller is taken as the d/q-axis output instruction, and the sum of the output of the load voltage 0-axis PI controller and the output of the grid-side current 0-axis PI controller is taken as the 0-axis output instruction; hereby, on the one hand, the load voltage zero sequence is stabilized, and on the other hand, the grid-side winding zero sequence circulating current is avoided to be oversized; the controller output is applied to the HDT current compensation converter, in conjunction with the main transformer excitation current nonlinear feedback, a stable grid synchronous flux linkage is established for the HDT main transformer before closing, which is the main transformer excitation current superposition feedback strategy CS3. For the voltage compensation converter, the isolation transformer pre-magnetizing strategy CS5 is to feed back the output voltage of the d/q/0 axis isolation transformer in synchronous rotation coordinates, and the output of its PI controller is applied to the HDT voltage compensation converter, in conjunction with the main transformer and isolation transformer excitation current superposition feedback strategy CS6, i.e., main transformer and isolation transformer excitation current non-linear feedback, thereby establishing a stable flux linkage for the HDT isolation transformer before closing.

Wherein, the 0-axis output instruction is equal to the sum of the output of the load voltage 0-axis PI controller and the output of the grid-side current 0-axis PI controller. This arrangement, on the one hand, stabilizes the load voltage zero sequence and, on the other hand, avoids that the grid-side winding zero sequence circulation current is too much.

Step 3, in response to determining that the HDT is closed after no-load closing, sinusoidal symmetric control of the grid-side current is realized through the HDT current compensation converter, and the load voltage is stabilized with the HDT voltage compensation converter. The grid-side current control strategy CS1 and the main transformer excitation current superposition feedback strategy CS3 control the current compensation converter CVp; at the same time, the load voltage control strategy CS4 and the main transformer and isolation transformer excitation current superposition feedback strategy CS6 control the voltage compensation converter CVt.

For the current compensation converter, the grid-side current control strategy CS1 is to superimpose a main transformer excitation current feedback term after each phase original control instruction at stationary coordinates, specifically to feed back the d/q/0 axis grid-side current, the output of each axis PI controller acts directly on the HDT current compensation converter, in conjunction with the main transformer excitation current superposition feedback strategy CS3, i.e. main transformer excitation current non-linear feedback, as a result, after the HDT is closed, sinusoidal symmetry control of the grid-side current is realized on the on hand, and the DC magnetic bias of the main transformer is overcome on the other hand. For the HDT voltage compensation converter, the load voltage control strategy CS4 is to superimpose the feedback terms of the main transformer excitation current and the isolation transformer excitation current after each phase original control instruction, specifically to feed back the d/q/0 axis load voltage, apply each PI controller output to the HDT voltage compensation converter, and the main transformer and isolation transformer excitation current superposition feedback strategy CS6 combines the main transformer and isolation transformer excitation current non-linear feedback to stabilize the HDT load voltage after closing and avoid magnetic saturation of the HDT isolation transformer.

Preferably, the main transformer excitation current of each phase is calculated based on the magnetic potential balance principle from the primary winding, secondary winding, and control winding currents of the main transformer, while the excitation current of each phase of the isolation transformer is calculated based on the magnetic potential balance principle from the valve-side winding and grid-side winding currents of the isolation transformer.

Specifically, to achieve nonlinear superposition feedback of the excitation currents of the main transformer and the isolation transformer, first, the symbolic square root of the excitation current is determined, then multiplied by a proportional coefficient, and finally superimposed onto the original control command of each phase of the HDT. For the current compensation converter of the HDT, the feedback term of the excitation current of the main transformer needs to be superimposed after the original control instruction of each phase in the stationary coordinates. For the voltage compensation converter of the HDT, the feedback terms of the excitation current of the main transformer and the excitation current of the isolation transformer need to be superimposed after the original control command of each phase. The excitation current of each phase of the main transformer is calculated based on the magnetic potential balance principle from the primary winding, secondary winding, and control winding currents of the main transformer, while the excitation current of each phase of the isolation transformer is calculated based on the magnetic potential balance principle from the valve-side winding and grid-side winding currents of the isolation transformer.

This is further illustrated below in connection with specific embodiments:

### EMBODIMENTS

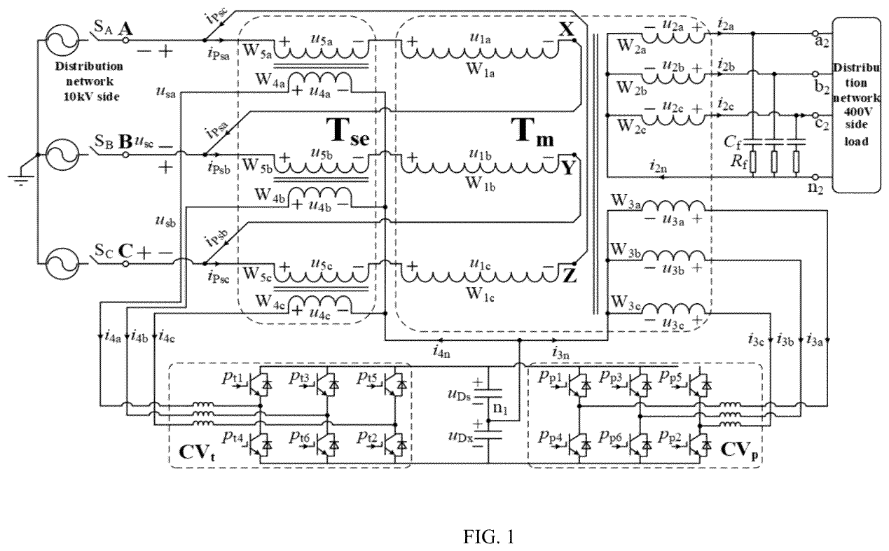

Referring to FIG. 1, the main circuit configuration of the hybrid distribution transformer in this embodiment is as shown in FIG. 1. The HDT includes a main transformer Tm, an isolation transformer Tse, a voltage compensation converter CVt, and a current compensation converter CVp. The main transformer Tm includes primary windings (W1a, W1b, W1c), secondary windings (W2a, W2b, W2c), and control windings (W3a, W3b, W3c), and the isolation transformer Tse includes grid-side windings (W5a, W5b, W5c), and valve-side windings (W4a, W4b, W4c). The primary windings (W1a, W1b, W1c) are connected in series with the grid-side windings (W5a, W5b, W5c) in a delta connection and are connected to the 10 kV side of the distribution network through the grid-side circuit breakers (SA, SB, SC). The output sides of the secondary windings (W2a, W2b, W2c) are connected to the RC filter and a star neutral point lead-out connection method is adopted to supply power to the load. The control windings (W3a, W3b, W3c) and the valve side windings (W4a, W4b, W4c) are connected to CVp and CVt in accordance with a star neutral line lead-out connection method.

To achieve magnetic bias suppression, the HDT needs to install 16 current sensors to collect the grid-side currents (iPsa, iPsb, iPsc), the secondary winding currents (i2a, i2b, i2c), the control winding currents (i3a, i3b, i3c) of the main transformer Tm and the valve side winding currents (i4a, i4b, i4c) of the isolation transformer Tse in FIG. 1, respectively. It is also necessary to install 14 voltage sensors to collect the grid-side voltages (usa, usb, usc), the load voltages (u2a, u2b, u2c), the grid-side winding voltages (u5a, u5b, u5c) and the DC bus capacitance voltages (uDs, uDx) of the HDT in FIG. 1, respectively.

The magnetic bias active suppression method of a hybrid distribution transformer in this embodiment includes the following steps:

Step 1, whether the HDT is closed is judged based on a grid-side current.

In this step, the excitation currents (im1a, im1b, im1c) of the main transformer Tm and the excitation currents (im2a, im2b, im2c) of the isolation transformer Tse are determined from the measured winding currents, as shown in Equation (1).

$$\{ \begin{matrix}{i}_{mla} = {K}_{13} {i}_{Psa} - {i}_{3 a} - {K}_{23} {i}_{2 a} , {i}_{m 2 a} = {K}_{54} {i}_{Psa} - {i}_{4 a} \\ {i}_{mlb} = {K}_{13} {i}_{Psb} - {i}_{3 b} + {K}_{23} {i}_{2 b} , {i}_{m 2 b} = {K}_{54} {i}_{Psb} - {i}_{4 b} \\ {i}_{mlc} = {K}_{13} {i}_{Psc} - {i}_{3 c} + {K}_{23} {i}_{2 c} , {i}_{m 2 c} = {K}_{54} {i}_{Psc} - {i}_{4 c}\end{matrix} \qquad ( 1 )$$

Wherein, K13 is the ratio of the primary windings (W1a, W1b, W1c) to the control windings (W3a, W3b, W3c) and K23 is the ratio of the secondary windings (W2a, W2b, W2c) to the control windings (W3a, W3b, W3c). K54 is the ratio of the grid-side windings (W5a, W5b, W5c) to the valve-side windings (W4a, W4b, W4c).

To determine whether the grid-side circuit breakers (SA, SB, SC) of the HDT in FIG. 1 are closed or not, the sum of the three phase absolute values of the grid-side line currents is determined by measuring the grid-side currents (iPsa, iPsb, iPsc) of the main transformer Tm in conjunction with Equation (2), and is denoted as ism.

$${i}_{sm} = \vert {i}_{Psa} - {i}_{Psc} \vert + \vert {i}_{Psb} - {i}_{Psa} \vert + \vert {i}_{Psc} - {i}_{Psb} \vert \qquad ( 2 )$$

Obviously, the grid-side circuit breakers (SA, SB, SC) in FIG. 1 can be determined to be in the closed state when ism>isyz (isyz is a small threshold value slightly greater than 0), and the grid-side circuit breakers (SA, SB, SC) in FIG. 1 can be determined to be in the open state when ism<0.

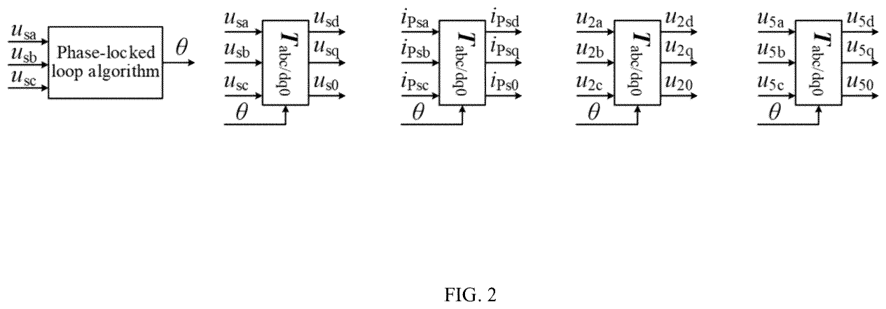

The magnetic bias suppression strategy of the present disclosure based on working condition switching and superimposition feedback of excitation current can be seen in FIGS. 2, 3, 4 and 5. The coordinate transformation matrices required for FIGS. 2, 3, and 5 are shown in Equations (3) and (4). The synchronization phase signal θ used in (3) and (4) and FIG. 2 is obtained by phase locking the grid-side voltages (usa, usb, usc).

$${T}_{abc / dq 0} = \frac{2}{3} [ \begin{matrix}sin θ & sin ( θ - 2 π / 3 ) & sin ( θ + 2 π / 3 ) \\ cos θ & cos ( θ - 2 π / 3 ) & cos ( θ + 2 π / 3 ) \\ 1 / 2 & 1 / 2 & 1 / 2\end{matrix} ] \qquad ( 3 )$$

$${T}_{dq 0 / abc} = [ \begin{matrix}sin θ & cos θ & 1 \\ sin ( θ - 2 π / 3 ) & cos ( θ - 2 π / 3 ) & 1 \\ sin ( θ + 2 π / 3 ) & cos ( θ + 2 π / 3 ) & 1\end{matrix} ] \qquad ( 4 )$$

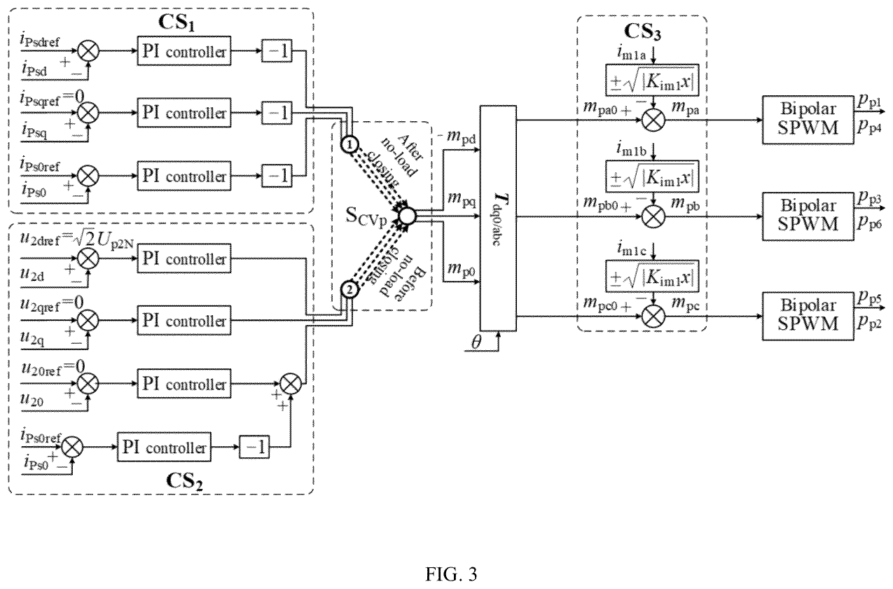

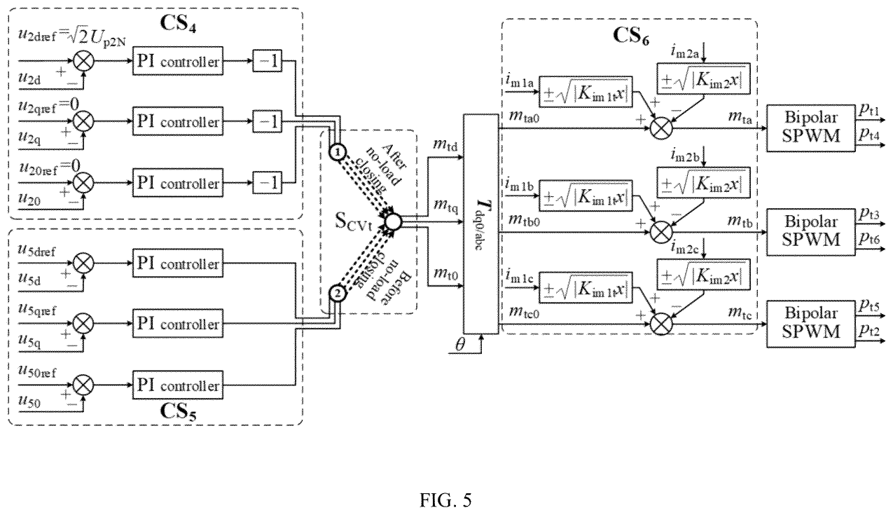

Referring to FIGS. 3 and 5, the HDT magnetic bias suppression strategy of the present disclosure based on working condition switching and superimposition feedback of excitation current is directed to the current compensation converter CVp and the voltage compensation converter CVt, respectively.

Step 2, in response to determining that the HDT is not closed before closing. A load voltage is stabilized through the HDT current compensation converter, and a grid-side zero-sequence current is limited, and grid-side voltage fluctuations are compensated by the HDT voltage compensation converter. The specific operations are: both SCVp and SCVt connect to a contact \textcircled{2}, a current compensation converter CVp is controlled by a main transformer pre-magnetizing strategy CS2 and a main transformer excitation current superposition feedback strategy CS3; at the same time, a voltage compensation converter CVt is controlled by an isolation transformer pre-magnetizing strategy CS5 and a main transformer and isolation transformer excitation current superposition feedback strategy CS6. In this case, the CVp and CVt can be used respectively to establish a steady state flux linkage synchronized with the grid voltage for Tm and Tse in advance prior to unload closing.

The strategy is implemented on the principle that if the excitation currents of Tm and Tse are 0, it indicates that the magnetic biases of both Tm and Tse are not severe, and neither of them is saturated, so that the excitation current feedback loops of CS3 and CS6 will not generate control actions. In this case, only CS2 and CS5 will generate control actions, and the pre-magnetization of Tm and Tse will proceed normally. If the excitation currents of Tm and Tse are significantly greater than 0, it indicates that the transformers have a large degree of magnetic bias and obvious magnetic saturation. At this time, CS3 and CS6 will produce significant control actions, and the control signals generated by them will be superimposed on the original modulation signals (mpa0, mpb0, mpc0) and (mta0, mtb0, mtc0) to actively correct the flux linkages of Tm and Tse to ensure that the magnetic biases of Tm and Tse are rapidly reduced below the saturation point. As a result, before closing, the flux linkages of Tm and Tse are ensured to be steady-state flux linkages that are always synchronized with the grid.

The magnetic bias suppression effect of (im1a, im1b, im1c) on Tm in CS6 before no-load closing is weak, and the Tse pre-magnetizing effect is deteriorated if the feedback coefficient Kimlt is too large. Preferably, therefore, Kimlt needs to be adjusted following the state of SCVt, and when SCVt connects to a contact \textcircled{2}, Kimlt should be approximately taken as 0.

2) If it is determined that HDT is in the closed state based on ism, the grid-side current sinusoidal symmetry control is achieved using the HDT current compensation converter, and the load voltage is stabilized using the HDT voltage compensation converter. The specific operations are as follows: SCVp and SCVt both connect to a contact \textcircled{1}, and the grid-side current control strategy CS1 and the main transformer excitation current superposition feedback strategy CS3 implement control over the current compensation converter CVp. At the same time, the load voltage control strategy CS4 and the main transformer and isolation transformer excitation current superposition feedback strategy CS6 implement control over the voltage compensation converter CVt. During this process, CVp achieves sinusoidal, unity power factor, and symmetric control of the grid current, while CVt ensures symmetric sinusoidal stability control of the load voltage. Additionally, the excitation current superposition feedback can correct the iron core flux linkage in real-time, thereby eliminating the DC magnetic bias of the iron cores of Tm and Tse.

The implementation principle of the strategy is as follows: if the excitation currents of Tm and Tse are 0, it indicates that the magnetic biases of both Tm and Tse are not severe, and neither of them is saturated. Therefore, the excitation current feedback loops of CS3 and CS6 will not generate control actions. In this case, only CS1 and CS4 will respectively generate control actions for CVp and CVt. After closing, the grid-side current of HDT is always controlled to be a sinusoidal symmetric wave, and the load voltage is controlled to be a stable symmetric sinusoidal wave. If the excitation currents of Tm and Tse are significantly greater than 0, it indicates that magnetic bias occurs in the transformers, and magnetic saturation is obvious. In this case, CS3 and CS6 will generate significant control actions to actively correct the flux linkages of Tm and Tse, ensuring that the magnetic biases of Tm and Tse are rapidly reduced below the saturation point. Consequently, after closing, Tm and Tse remain unsaturated, and the grid-side current and load voltage control functions of HDT are not affected.

The effect of CS3 on the magnetic bias suppression of Tm after no-load closing is weak, and if the feedback coefficient Kim1 is too large, the grid-side current control effect is deteriorated. Preferably, therefore, Kim1 still needs to be adjusted following the state of SCVp, and Kim1 should be taken to be approximately 0 when SCVp connects to a contact \textcircled{1}.

After the no-load closing, in fact, CVt utilizes CS6 to simultaneously suppress the magnetic biases of Tse and Tm. Specifically, when (im1a, im1b, im1c) are significantly greater than 0, CS6 will add a control effect, thereby affecting the output voltage of Tse. Since the grid voltages (usa, usb, usc) cannot be actively changed after closing, Tse can indirectly influence the terminal voltage of Tm and further affect its iron core flux linkage, thus eliminating the DC magnetic bias of Tm. When (im2a, im2b, im2c) are significantly greater than 0, CS6 will directly affect the flux lingkage of Tse, further eliminating the magnetic bias.

Wherein, the control strategy for the current compensation converter CVp includes the grid-side current control strategy CS1, the main transformer pre-magnetizing strategy CS2, the closing condition judgment and logic switching switch SCVp, and the main transformer excitation current superposition feedback strategy CS3.

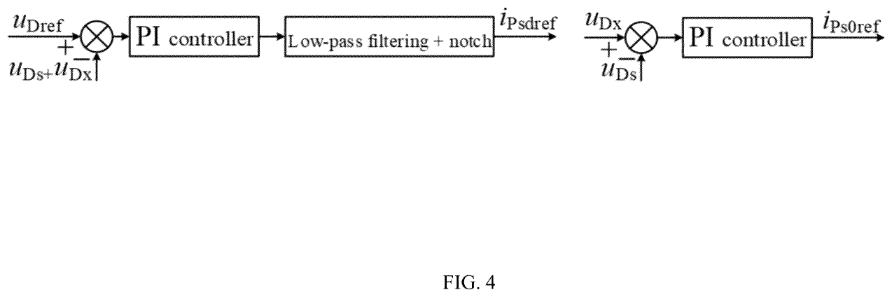

The CS1 requires feedback of the d/q/0 axis grid-side currents (iPsd, iPsq, iPs0) and calculates the deviations between (iPsd, iPsq, iPs0) and their respective reference signals (iPsdref, iPsgreg, iPs0ref). These deviations are used as the inputs for the PI controllers of axes. The inverted outputs of the PI controllers of axes serve as inputs for the subsequent SCVp. The reference signals iPsdref and iPs0ref of CS1 come from the output of the HDT DC bus voltage outer loop control shown in FIG. 4. Wherein, the reference signal iPsdref comes from the DC bus voltage stability control strategy CSuD, while the reference signal iPs0ref comes from the DC bus split capacitor voltage deviation suppression strategy CSuDd.

The CS2 requires feedback of the d/q/0-axis load voltages (u2d, u2q, u20) and the 0-axis component of the grid-side current iPs0 in the synchronous rotating coordinates, and calculates the deviations between (u2d, u2q, u20, iPs0) and their respective reference signals (u2dref, u2qref, u20ref, iPs0ref). The deviations are used as the inputs for the PI controllers of axes. The outputs of the PI controllers of axes serve as the inputs for the subsequent SCVp, wherein the outputs of the PI controllers related to u20 and iPs0 are summed to produce the 0-axis output.

Based on the state of the SCVp, the outputs of axes of CS1 and CS2 are taken as the original modulation signals (mpd, mpq, mp0) of CVp in the synchronous coordinates. By performing inverse coordinate transformation on (mpd, mpq, mp0), the original modulation signals (mpa0, mpb0, mpc0) of each phase for CVp can be generated.

The CS3 requires feedback of the excitation currents (im1a, im1b, im1c) of respective phases of the main transformer. After performing symbolic root finding for (im1a, im1b, im1c), the respective root results are multiplied by a feedback coefficient Kim1, and products are subtracted by original modulation signals of phases (mpa0, mpb0, mpc0), the final modulation signals of phases (mpa, mpb, mpc) can be obtained to control CVp.

Wherein, regarding the control strategy for the voltage compensation converter CVt, it includes the load voltage control strategy CS4, the isolation transformer pre-magnetizing strategy CS5, the closing working condition judgment and logic switching switch SCVt, as well as the main transformer and isolation transformer excitation current superposition feedback strategy CS6.

The CS4 requires feedback of the d/q/0-axis load voltages (u2d, u2q, u20) and calculates the deviations between (u2d, u2q, u20) and their respective reference signals (u2dref, u2qref, u20ref). These deviations are used as the inputs to the PI controllers of axes. The inverted outputs of the PI controllers of axes are then used as the input to the subsequent SCVt.

The CS5 requires feedback of the d/q/0-axis load voltages (u5d, u5q, u50) and calculates the deviations between (u5d, u5q, u50) and their respective reference signals (u5dref, u5qref, u50ref). These deviations are used as the inputs to the PI controllers of axes. The inverted outputs of the PI controllers of axes are then used as the input to the subsequent SCVt. The reference signals (u5dref, u5qref, u50ref) for CS5 are calculated using Equation (5).

$$\{ \begin{matrix}{u}_{5 dref} = \sqrt{2} {U}_{p 1 N} - {u}_{sd} \\ {u}_{5 qref} = - {u}_{sq} \\ {u}_{50 ref} = - {u}_{s 0}\end{matrix} \qquad ( 5 )$$

Wherein, Up1N represents the rated line-to-line voltage of the 10 kV side of the distribution network.

Based on the state of the SCVt, the outputs of axes of CS4 and CS5 are used as the original modulation signals (mtd, mtq, mt0) of the CVt in synchronous coordinates. Through inverse coordinate transformation of (mtd, mtq, mt0), the original modulation signals of phases (mta0, mtb0, mtc0) for the CVt can be generated.

CS6 requires feedback of the excitation currents (im1a, im1b, im1c) and (im2a, im2b, im2c) of the main transformer and the isolation transformer. The excitation currents (im1a, im1b, im1c) and (im2a, im2b, im2c) are multiplied by the feedback coefficients Kim1t and Kim2, respectively, and then symbolic root finding is performed. The outputs are then superimposed on the original modulation signals of phases (mta0, mtb0, mtc0), resulting in the final modulation signals of phases (mta, mtb, mtc).

According to the control strategies shown in FIGS. 3 and 5, the modulation signals (mpa, mpb, mpc) and (mta, mtb, mtc) of CVp and CVt can be ultimately generated. Using dual-polarity SPWM, the driving pulses (pp1, pp4, pp3, pp6, pp5, pp2) and (pt1, pt4, pt3, pt6, pt5, pt2) of CVp and CVt can be generated. These driving pulses can control the current compensation converter CVp and the voltage compensation converter CVt to execute the magnetic bias suppression strategy.

The foregoing is only a preferred embodiment of the present disclosure, and is not intended to limit the present disclosure. Any modification, equivalent replacement, improvement, etc. made within the spirit and principles of the present disclosure should be included in the scope of protection of the present disclosure.

What is claimed is:

1. A magnetic bias active suppression method of a hybrid distribution transformer, comprising the steps of:
step 1, judging whether the HDT is closed based on a grid-side current, and in response to determining that the HDT is not closed, executing step 2; in response to determining that the HDT is closed, executing step 3;
step 2, controlling a HDT current compensation converter by a main transformer pre-magnetizing strategy and a main transformer excitation current superposition feedback strategy, and controlling a HDT voltage compensation converter by an isolation transformer pre-magnetizing strategy and a main transformer and isolation transformer excitation current superposition feedback strategy;
stabilizing a load voltage through an output of the HDT current compensation converter, limiting a zero-sequence circulating current within a grid-side winding in a delta connection; compensating for grid-side voltage fluctuations by an output of the HDT voltage compensation converter;
step 3, controlling the HDT current compensation converter by a grid-side current control strategy and a main transformer excitation current superposition feedback strategy, and controlling the HDT voltage compensation converter by a load voltage control strategy and the main transformer and isolation transformer excitation current superposition feedback strategy; and
making the grid-side current sinusoidally symmetric by the output of the HDT current compensation converter, and stabilizing the load voltage by the output of the HDT voltage compensation converter.

2. The magnetic bias active suppression method of a hybrid distribution transformer according to claim 1, wherein, in step 1, the grid-side current of a main transformer is measured, and the sum of three phase absolute values of the grid-side current is obtained from the grid-side current, and in response to determining that the sum is greater than a set threshold value, the HDT is in the closed state, and in response to determining that the sum is less than 0, the HDT is in the open state.

3. The magnetic bias active suppression method of a hybrid distribution transformer according to claim 1, wherein, in step 2, the main transformer pre-magnetizing strategy is: inputting a d-axis load voltage, a q-axis load voltage, and a 0-axis load voltage of a secondary winding and a grid-side current 0-axis component into synchronous rotation coordinates, obtaining deviations by respectively subtracting them by respective reference signals, inputting each deviation into each axis PI controller, and taking outputs of a d-axis PI controller and a q-axis controller as d-axis and q-axis output instructions of a total controller; taking the sum of the output of a load voltage 0-axis PI controller and the output of a grid-side current 0-axis PI controller as a 0-axis output instruction.

4. The magnetic bias active suppression method of a hybrid distribution transformer according to claim 1, wherein in step 2, the isolation transformer pre-magnetizing strategy is: obtaining a d-axis load voltage, a q-axis load voltage and a 0-axis load voltage of a grid-side winding, obtaining deviations by respectively subtracting them by respective reference signals, inputting each deviation into each axis PI controller, and inputting an output value of each axis PI controller into a HDT voltage compensator.

5. The magnetic bias active suppression method of a hybrid distribution transformer according to claim 1, wherein in step 3, the grid-side current control strategy is: obtaining a d-axis grid-side current, a q-axis grid-side current and a 0-axis grid-side current of the main transformer, obtaining deviations by respectively subtracting them by respective reference signals, inputting each deviation into each axis PI controller, and inputting an output of each axis PI controller into a HDT current compensation converter.

6. The magnetic bias active suppression method of a hybrid distribution transformer according to claim 1, wherein in step 3, the load voltage control strategy is: inputting a d-axis load voltage, a q-axis load voltage and a 0-axis load voltage of the secondary winding into the synchronous rotation coordinates, obtaining deviations by respectively subtracting them by respective reference signals, inputting each deviation into each axis PI controller, and inputting an output value of each axis PI controller into the HDT voltage compensator.

7. The magnetic bias active suppression method of a hybrid distribution transformer according to claim 1, wherein in step 2 and step 3, the main transformer excitation current superposition feedback strategy is: after performing symbolic root finding for the excitation current of each phase of the main transformer, multiplying the respective root result by a feedback coefficient, and obtaining an output value of the HDT current compensation converter by subtracting each product by an original modulation signal of each phase.

8. The magnetic bias active suppression method of a hybrid distribution transformer according to claim 1, wherein in step 2 and step 3, the main transformer and isolation transformer excitation current superposition feedback strategy is: obtaining the excitation current of each phase of the main transformer and the excitation current of each phase of the isolation transformer; multiplying the excitation current of each phase of the main transformer by a feedback coefficient Kᵢₘᵢₜ, and multiplying the excitation current of each phase of the isolation transformer by a feedback coefficient Kᵢₘ₂; after performing root finding for each product, obtaining a final modulation signal of each phase by superimposing the root value onto an original modulation signal of each phase; and inputting the final modulation signal into the HDT voltage compensation converter.

9. The magnetic bias active suppression method of a hybrid distribution transformer according to claim 8, wherein in step 2, the feedback coefficient Kᵢₘᵢₜ is approximately taken as 0; in step 3, the feedback coefficient Kᵢₘᵢₜ is approximately taken as 0.

10. A magnetic bias active suppression system of a hybrid distribution transformer, comprising:
a judging module, used for judging whether the HDT is closed based on a grid-side current, and in response to determining that the HDT is not closed, executing a non-closure module; in response to determining that the HDT is closed, executing a closure module;
a non-closure module, used for controlling a HDT current compensation converter by a main transformer pre-magnetizing strategy and a main transformer excitation current superposition feedback strategy, and controlling a HDT voltage compensation converter by an isolation transformer pre-magnetizing strategy and a main transformer and isolation transformer excitation current superposition feedback strategy;
stabilizing a load voltage through an output of the HDT current compensation converter, limiting a grid-side zero-sequence current; compensating for grid-side voltage fluctuations by an output of the HDT voltage compensation converter;
a closure module, used for controlling the HDT current compensation converter by a grid-side current control strategy and a main transformer excitation current superposition feedback strategy, and controlling the HDT voltage compensation converter by a load voltage control strategy and the main transformer and isolation transformer excitation current superposition feedback strategy; and
making the grid-side current sinusoidally symmetric by the output of the HDT current compensation converter, and stabilizing the load voltage by the output of the HDT voltage compensation converter.
